(19) United States
(12) Patent Application Publication
(10) Pub. No.: US 2007/0208096 A1
(43) Pub. Date: Sep. 6, 2007

(54) Sulfonated aromatic polyester polyol compositions

(75) Inventors: Alberto DeLeon, Houston, TX (US); David J. Shieh, Sugarland, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: OXID L.P.

(21) Appl. No.: 11/366,185

(22) Filed: Mar. 2, 2006

(51) Int. Cl. C08G 18/48; C08G 18/00; H01M 4/88

(52) U.S. Cl. 521/131; 521/172; 252/182.1

(57) ABSTRACT

Aromatic polyester polyols comprising the inter-esterification product of at least one phthalic acid based material, at least one hydroxylated material having a functionality of at least 2, and at least one low molecular weight sulfonated compound, are provided. These polyols may optionally include at least one hydrophobic material as an inter-esterification reactant. Also provided are methods for preparing such polyols. Further described are polyol-based compositions prepared using such polyols and a blowing agent, as well as methods for preparing such polyol-based compositions. Polyisocyanurate and polyurethane foams made from such polyol-based compositions, and to methods for preparing such polyisocyanurate and polyurethane foams are also described.

### FIELD OF THE INVENTION

The present invention relates to certain aromatic polyester polyols suitable for use in polyisocyanurate and polyurethane foams, and methods for preparing such polyols. In particular, the invention relates to aromatic polyester polyols comprising the inter-esterification product of at least one phthalic acid based material, at least one hydroxylated material having a functionality of at least 2, and at least one low molecular weight sulfonated compound. The polyols of the present invention may optionally include at least one hydrophobic material as an interesterification reactant. The present invention also relates to polyol-based compositions prepared using such polyols and blowing agents, for example, water and/or C₄-C₇ hydrocarbons. The present invention further relates to polyisocyanurate and polyurethane foams made from such polyol-based compositions, and to methods for preparing such polyisocyanurate and polyurethane foams.

### DESCRIPTION OF RELATED ART

Polyols are useful reactants in preparing a variety of polymeric compositions. Aromatic polyester polyols are widely used in the manufacture of polyisocyanurate and polyurethane foams. Typically, polyols are employed in reactions involving curing or crosslinking with polyisocyanate materials having at least two isocyanate groups per mole.

Aromatic polyester polyols are attractive because they tend to be low in cost, yet can be used to produce a wide variety of cellular foams having excellent properties and adaptable for many end use applications. One class of aromatic polyester polyols that has enjoyed wide commercial success comprises the polyol products produced by esterification of a phthalic acid based material with an aliphatic polyhydric alcohol. See, e.g., U.S. Pat. Nos. 4,714,717 and 4,652,591 (to Jim Walter Resources, Inc.). A hydrophobic material such as a fat or oil may optionally be inter-esterified into the aromatic polyester polyol in order to render the polyol more hydrophobic. See, e.g., U.S. Pat. No. 6,133,329 (to Oxid L.P.) and U.S. Pat. No. 6,359,022 (to Stepan Company). However, these prior art polyols still may not always be entirely compatible with certain zero ozone depletion potential (ODP) blowing agents, such as water and/or C₄-C₇ hydrocarbons.

Thus, there is a need for aromatic polyester polyols that are more fully compatible with these blowing agents, and that are economical to produce and can be used to provide polyisocyanurate and polyurethane foams having excellent properties.

### SUMMARY OF THE INVENTION

The present invention relates to a new and surprisingly useful class of aromatic polyester polyols suitable for use in polyisocyanurate and polyurethane foams, comprising the inter-esterification product of at least one phthalic acid based material, at least one hydroxylated material having a functionality of at least 2, and at least one low molecular weight sulfonated compound. The polyols of the present invention may optionally also include at least one hydrophobic material as an inter-esterification reactant. The present invention also relates to methods for preparing such polyols. The present invention further relates to polyol-based compositions prepared using such polyols and a blowing agent. The present invention further still relates to methods for preparing such polyol-based compositions. The present invention further relates to polyisocyanurate and polyurethane foams made from such polyol-based compositions, and to methods for preparing such polyisocyanurate and polyurethane foams.

The aromatic polyester polyols of the present invention may be utilized with a wide variety of blowing agents, including for example, hydrocarbons, water, hydrofluorocarbons, perfluorinated hydrocarbons, chlorofluorocarbons, and non-chlorofluorocarbon blowing agents. The aromatic polyester polyols of the present invention can be readily blended with prior art polyols, if desired, and also with various additives conventionally used in the formulation of polyol-based compositions (i.e., “b-sides”). The aromatic polyester polyols of the invention are prepared by an inter-esterification process that is simple, reliable and well adapted for conventional chemical processing equipment.

Thus, in one exemplary aspect of the invention, there is provided an aromatic polyester polyol comprising the inter-esterification product of reactants comprising:
(a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
(b) from about 10 to about 70 percent by weight of at least one hydroxylated material having a functionality of at least 2; and
(c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups and mixtures thereof.

Such aromatic polyester polyols may optionally include as an inter-esterification reactant from more than 0 to about 50 percent by weight at least one hydrophobic material characterized by
(i) containing from about 8 to 60 carbon atoms; and
(ii) containing at least one and not more than four radicals per molecule, the radicals being selected from the group consisting of carboxylic acid groups, carboxylic acid ester groups, hydroxyl groups, and mixtures thereof.

Such aromatic polyester polyols are preferably characterized by having:
(1) an hydroxyl number ranging from about 30 to about 500;
(2) an acid number ranging from about 0.1 to about 7;
(3) a functionality of from about 1.3 to about 3; and
(4) a viscosity ranging from about 200 to about 50,000 centipoises at 25° C., measured using a Brookfield viscometer.

The inter-esterification reaction may be performed with or without a suitable esterification catalyst. Typically, and preferably, the inter-esterification reaction is performed with a suitable esterification catalyst known to those of ordinary skill in the art.

Generally, the inter-esterification reactions of the present invention are carried out under vacuum conditions, at temperatures sufficient to effect the desired esterification reaction, and water is removed from the reaction contents as the esterification proceeds. Typically, the esterification reaction is performed at a temperature of about 100° C. to about 300° C. More preferably, the esterification is performed at a temperature of about 180° C. to about 280° C.

In another exemplary aspect of the invention, there are provided polyol-based compositions comprising:
(A) a polyol component comprising:
   (I) from about 20 to about 100 percent by weight of an aromatic polyester polyol comprising the inter-esterification product of reactants comprising:
      (a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
      (b) from about 10 to about 70 percent by weight of at least one hydroxylated material having a functionality of at least 2; and
      (c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups and mixtures thereof; and
   (II) from 0 to about 80 percent by weight of a polyether polyol; and
(B) from about 0.1 to about 35 parts (by weight) per hundred of polyol component, of an added blowing agent.

In still another exemplary aspect of the invention, there is provided a method for preparing a polyisocyanate-based foam, comprising reacting a polyisocyanate and a polyol-based composition, wherein the polyol-based composition comprises:
(A) a polyol component comprising:
   (I) from about 20 to about 100 percent by weight of an aromatic polyester polyol comprising the inter-esterification product of reactants comprising:
      (a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
      (b) from about 10 to about 70 percent by weight of at least one hydroxylated material having a functionality of at least 2; and
      (c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups and mixtures thereof; and
   (II) from 0 to about 80 percent by weight of a polyether polyol; and
(B) from about 0.1 to about 35 parts (by weight) per hundred of polyol component, of a blowing agent.

### DETAILED DESCRIPTION OF THE INVENTION

### Aromatic Polyester Polyols

One embodiment of present invention comprises the aromatic polyester polyol reaction product formed by inter-esterification of a ternary system comprising at least one phthalic acid based material, at least one hydroxylated material having a functionality of at least 2; and at least one low molecular weight sulfonated compound. Anther embodiment of present invention includes the aromatic polyester polyol reaction product formed by inter-esterification of a quaternary system comprising at least one phthalic acid based material, at least one hydroxylated material having a functionality of at least 2; at least one low molecular weight sulfonated compound; and at least one hydrophobic material.

The term inter-esterification as used herein means that the phthalic acid based material is esterified and/or transesterified by the hydroxylated material and/or the sulfonated compound and/or the hydrophobic material (if present), the hydroxylated material is additionally esterified and/or transesterified by the sulfonated compound and/or the hydrophobic material (if present), and the sulfonated compound is additionally esterified and/or transesterified by the hydrophobic material (if present), to produce an inter-esterification product. This inter-esterification product thus contains one or more phthalic acid moieties randomly interspersed between the hydroxylated material, the sulfonated compound and/or the hydrophobic material (if present).

As described more fully below, in one embodiment of the present invention, the aromatic polyester polyol reaction product is formed by inter-esterification of reactants comprising:
(a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
(b) from about 10 to about 70 percent by weight of at least one hydroxylated material having a functionality of at least 2; and
(c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups and mixtures thereof.

The aromatic polyester polyol reaction product of the present invention is optionally prepared using as an inter-esterification reactant, from more than 0 to about 50 percent by weight at least one hydrophobic material characterized by
(i) containing from about 8 to 60 carbon atoms; and
(ii) containing at least one and not more than four radicals per molecule, the radicals being selected from the group consisting of carboxylic acid groups, carboxylic acid ester groups, hydroxyl groups, and mixtures thereof.

The term functionality as used herein means the number of reactive groups, e.g., hydroxyl groups, in a molecule. The term “polyester polyol” as used herein means a polyol having ester linkages.

The amount of phthalic acid based material reactant, based on the combined weight of phthalic acid based material, hydroxylated material, sulfonated compound and any hydrophobic material, is from about 10 to about 70 percent by weight, more preferably from about 30 to about 60 percent by weight, and most preferably about 35 to about 50 percent by weight. The amount of hydroxylated material reactant, based on the combined weight of phthalic acid based material, hydroxylated material, sulfonated compound and any hydrophobic material, is from about 10 to about 70 percent by weight, more preferably from about 30 to about 70 percent by weight, and most preferably about 35 to about 60 percent by weight. The amount of low molecular weight sulfonated compound reactant, based on the combined weight of phthalic acid based material, hydroxylated material, sulfonated compound and any hydrophobic material, is from about 0.1 to about 10 percent by weight, and more preferably from about 0.1 to about 5 percent by weight. When the resultant aromatic polyester polyol reaction product is to be combined with a blowing agent that mainly consists of water, the amount of the low molecular weight sulfonated compound reactant is most preferably from about 1 to about 6 percent by weight. When the resultant aromatic polyester polyol reaction product is to be combined with a blowing agent that mainly consists of a hydrocarbon such as a pentane, the amount of the low molecular weight sulfonated compound reactant is most preferably from about 4 to about 6 percent by weight. When present, the amount of hydrophobic material reactant, based on the combined weight of phthalic acid based material, hydroxylated material, sulfonated compound and the hydrophobic material, is from about greater than 0 to about 50 percent by weight, and more preferably from about 5 to about 25 percent by weight.

An aromatic polyester polyol reaction product according to the invention can include any minor amounts of unreacted hydroxylated material remaining after polyester polyol preparation and/or can include amounts of unesterified low molecular weight polyols (e.g., glycols) admixed with the prepared aromatic polyester polyol. The aromatic polyester polyol can include up to about 40 weight percent free glycol and glycol-type materials, based on the total weight of the aromatic polyester polyol. However, the free glycol content of the aromatic polyester polyols of the invention generally is from about 0 to about 20 weight percent, and usually from 1 to about 15 weight percent, based on the total weight of the aromatic polyester polyol.

It is possible, though less desirable, that the aromatic polyester polyols of the invention may also contain small amounts of residual, non-inter-esterified phthalic acid based material, sulfonated compounds and/or hydrophobic material. Typically, these non-inter-esterified materials will typically be present in an amount of less than about 20 percent by weight, based on the total weight of the components combined to form the aromatic polyester polyols of the invention.

The aromatic polyester polyols of the invention advantageously have an average functionality of about 1.3 to about 3. The aromatic polyester polyols of the present invention more preferably have an average functionality about 1.5 to about 2.5, or most preferably, from about 1.8 to about 2.4. The average hydroxyl number values of the aromatic polyester polyols of the invention generally fall within a range of about 30 to about 500, preferably about 50 to about 350 and more preferably about 100 to about 300 (taking into account the free glycols that may be present). The acid number of the aromatic polyester polyols of the invention generally fall within a range of about 0.1 to about 50, preferably about 0.5 to about 10 and more preferably about 0.5 to about 1.5.

Typically, the dynamic viscosity of the aromatic polyester polyols of the invention ranges from about 200 to about 50,000 centipoises (cps) at 25° C., measured using a Brookfield viscometer. In a more preferred embodiment, the dynamic viscosity of the aromatic polyester polyols of the invention will range from about 1000 to about 20,000 cps at 25° C., measured using a Brookfield viscometer.

In certain preferred embodiments, the phthalic acid based material may be selected from the group consisting of phthalic anhydride, terephthalic acid, polyethylene terephthalate, and mixtures thereof. In such preferred embodiments, the hydroxylated material may be selected from the group consisting of ethylene glycol, diethylene glycol, triethylene glycol, tetraethylene glycol, pentaerythritol and mixtures thereof, the low molecular weight sulfonated compound may be selected from the group consisting of a 5-sulfoisophthalic acid, sodium salt and dimethyl-5-sulfoisophthalate, sodium salt, and the hydrophobic material, if present, may be selected from the group consisting of corn oil, soybean oil and mixtures thereof.

It is preferred that the aromatic polyester polyols of the invention be prepared from inter-esterification reactants that are free from significant amounts of aliphatic dicarboxylic acids, such as adipic acid and the like. More preferably, the aromatic polyester polyols of the invention are prepared from inter-esterification reactants containing less than about 2 mole % aliphatic acids (based upon the total amount of dicarboxylic acid reactants). More preferably still, the aromatic polyester polyols of the invention are prepared from inter-esterification reactants containing less than about 1 mole % aliphatic acids (based upon the total amount of dicarboxylic acid reactants). Most preferably, the inter-esterification reactants are substantially free of aliphatic dicarboxylic acids.

A. Phthalic Acid Based Material

The aromatic polyester polyols of the invention can be prepared using a phthalic acid based material derived (a) from substantially pure sources of the phthalic acid residues, such as phthalic anhydride, phthalic acid, isophthalic acid, terephthalic acid, methyl esters of phthalic, isophthalic, or terephthalic acid, dimethyl terephthalate, polyethylene terephthalate, trimellitic anhydride, pyromellitic dianhydride, or mixtures thereof, or (b) from more complex ingredients such as the side stream, waste and/or scrap residues from the manufacture of phthalic acid, terephthalic acid, dimethyl terephthalate, polyethylene terephthalate, and the like. Especially suitable compositions containing phthalic acid residues for use in the invention are (a) ester-containing byproducts from the manufacture of dimethyl terephthalate, (b) scrap polyalkylene terephthalates, (c) phthalic anhydride, (d) residues from the manufacture of phthalic acid or phthalic anhydride, (e) terephthalic acid, (f) residues from the manufacture of terephthalic acid, (g) isophthalic acid, (h) trimellitic anhydride; or combinations thereof.

By phthalic acid residue is meant the group:

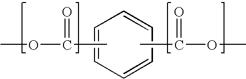

Preferred phthalic acid based materials are selected from the group consisting of phthalic anhydride, phthalic acid, isophthalic acid, terephthalic acid, methyl esters of phthalic, isophthalic, or terephthalic acid, dimethyl terephthalate, polyethylene terephthalate, trimellitic anhydride, pyromellitic dianhydride, or mixtures thereof. The phthalic acid based material may preferably be derived from residues from the manufacture of terephthalic acid, for example, as such compositions disclosed in U.S. Pat. No. 4,652,591, the entirety of which is incorporated herein by reference. The phthalic acid based material may also be derived from a phthalic anhydride bottoms composition, a phthalic anhydride crude composition, or a phthalic anhydride light ends composition, as such compositions are defined in U.S. Pat. No. 4,529,744, the entirety of which is also incorporated herein by reference.

Other useful phthalic acid based materials include, for example, polyalkylene terephthalates, especially polyethylene terephthalate (PET), or PET residues or scraps.

Still other useful phthalic acid based materials include DMT process residues, which are waste or scrap residues from the manufacture of dimethyl terephthalate (DMT). The term “DMT process residue” refers to the purged residue which is obtained during the manufacture of DMT in which p-xylene is converted through oxidation and esterification with methanol to the desired product in a reaction mixture along with a complex mixture of byproducts. The desired DMT and the volatile methyl p-toluate byproduct are removed from the reaction mixture by distillation leaving a residue. The DMT and methyl p-toluate are separated, the DMT is recovered and methyl p-toluate is recycled for oxidation. The residue that remains can be directly purged from the process or a portion of the residue can be recycled for oxidation and the remainder diverted from the process or, if desired, the residue can be processed further as, for example, by distillation, heat treatment and/or methanolysis to recover useful constituents which might otherwise be lost, prior to purging the residue from the system. The residue which is finally purged from the process, either with or without additional processing, is herein called DMT process residue.

These DMT process residues may contain DMT, substituted benzenes, polycarbomethoxy diphenyls, benzyl esters of the toluate family, dicarbomethoxy fluorenone, carbomethoxy benzocoumarins and carbomethoxy polyphenols. Cape Industries, Inc. sells DMT process residues under the trademark Terate®101. DMT process residues having a different composition but still containing the aromatic esters and acids are also sold by DuPont and others. The DMT process residues to be transesterified in accordance with the present invention preferably have a functionality at least slightly greater than 2. Such suitable phthalic acid based material residues include those disclosed in U.S. Pat. Nos. 3,647,759; 4,411,949; 4,714,717; and 4,897,429; the disclosures of each of which with respect to the residues are hereby incorporated by reference.

B. Hydroxylated Material

The hydroxylated material having a functionality of at least 2 may be a low molecular weight aliphatic diol of the generic formula
HO—R₁—OH

wherein R₁ is a divalent radical selected from the group consisting of:
(i) alkylene radicals each containing from 2 through 12 carbon atoms;
(ii) radicals of the formula —[CH₂—R₂—H₂]— wherein R₂ is a radical selected from the group consisting of 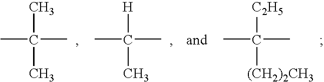
(iii) radicals of the formula —[(R₃O)ₙ—R₃]—
   wherein R₃ an alkylene radical containing from 2-4 carbon atoms and n is an integer from 1 through 10;
      and mixtures thereof.

Examples of suitable low molecular weight aliphatic diols include ethylene glycol, diethylene glycol, propylene glycol, dipropylene glycol, trimethylene glycol, triethylene glycol, tetraethylene glycol, butylene glycols, 1,4 butanediol, 1,6-hexanediol, 1,2-cyclohexanediol, pentaerythritol monoformal (i.e., 1,3-dioxane-5,5-dimethanol), poly(oxyalkylene)polyols containing from two to four alkylene radicals derived by the condensation of ethylene oxide, propylene oxide, or any combination thereof, and the like. As those skilled in the art will appreciate, in the preparation of mixed poly(oxyethylene-oxypropylene)polyols, the ethylene and propylene oxides may be added to a starting hydroxyl-containing reactant either in admixture or sequentially. Mixtures of such diols can be employed, if desired. Preferred aliphatic diols include diethylene glycol, triethylene glycol, tetraethylene glycol, pentaerythritol monoformal, and mixtures thereof.

The hydroxylated material having a functionality of at least 2 may also be a low molecular weight aliphatic higher functional polyol having less than about 7 carbons and between three and about eight hydroxyl groups. If used, such low molecular weight polyols can be employed either alone or in combination with aliphatic diols and are useful in an amount generally ranging from greater than 0 up to 100 percent by weight of the total hydroxylated material.

Such higher functional polyols may be of the general formula:
HO—R₄—OH

wherein R₄ is a divalent radical selected from the group consisting of:
i) radicals of the formula —[CH₂—R₅—CH₂]— wherein R₅ is a radical selected from the group consisting of 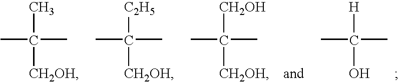
ii) radicals selected from the group consisting of glycerine, alkoxylated glycerine, sucrose, alkoxylated sucrose, methyl glucoside, alkoxylated methyl glucoside, glucose, alkoxylated glucose, fructose, alkoxylated fructose, sorbitol, alkoxylated sorbitol, lactose, and alkoxylated lactose;
and mixtures thereof.

Examples of useful higher functional polyols include pentaerythritol, dipentaerythritol, glycerol, 1,1,1-trimethylolpropane, 1,1,1-trimethylolethane and mixtures thereof. For reasons of economy, it may be advantageous to employ a low purity grade of pentaerythritol, such as that available under the tradename Corpent® 80, or the like.

Additionally, the hydroxylated material having a functionality of at least 2 may also be an amine-based aliphatic hydroxylated material (commonly termed hydroxylated amine). Useful aliphatic amine diols include but are not limited to diethanolamine. Useful aliphatic amine polyols include but are not limited to triethanolamine. Such hydroxylated amines can be employed either alone or in combination with other aliphatic diols or polyols.

C. Sulfonated Compounds

The term “low molecular weight sulfonated compound” as used herein means a compound having between one and three pendant sulfonate groups and from one to about four radicals selected from the group consisting of carboxylic acid groups, carboxylic acid ester groups, hydroxyl groups, amine groups and mixtures thereof. The term “sulfonate group” as used herein means —SO₃M, where M is hydrogen or a cation. Suitable cations include monovalent or polyvalent alkali metal cations, such as those of sodium, potassium or lithium; alkaline earth metal cations; other metal cations; or non-metalic cations such as ammonium-type cations and the like.

Suitable low molecular weight sulfonated compounds include those in which the sulfonate group(s) and above-referenced radical(s) are bound to an aromatic moiety, for example, the metal salts of sulfoarenedicarboxylic acids, such as 5-sulfoisophthalic acid, 5-sulfonaphthalene-1,4-dicarboxylic acid and 4,5-disulfonaphthalene-1,8-dicarboxylic acid. Suitable low molecular weight sulfonated compounds also include those in which the sulfonate group(s) and above-referenced radical(s) are bound to an aliphatic moiety, for example, the metal salts of sulfoalkanedicarboxylic acids.

Exemplary aromatic low molecular weight sulfonated compounds include those having the general formula: 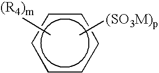
wherein each R₄ is a radical independently selected from the group consisting of carboxylic acid groups, carboxylic acid ester groups and amine groups; m is 1, 2, 3 or 4; M is hydrogen or a cation; and p is 1, 2 or 3. Preferably, the sulfonated component is a metal salt of 5-sulfoisophthalic acid or a lower alkyl ester of 5-sulfoisophthalate.

Exemplary aromatic monocarboxylic acid sulfonated compounds include the metal salts of 3-sulfobenzoic acid, 4-sulfobenzoic acid, and 5-sulfosalicylic acid. Exemplary aliphatic sulfonated compounds include the metal salts of sulfosuccinic acid, 2-sulfoglutaric acid, 2,5-disulfoadipic acid and 2-sulfododecanedioic acid. Further examples of specific aliphatic sulfonated compounds suitable for the present invention are:
I) isethionic acid, sodium salt, 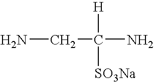
II) 3-hydroxyl-1-propane sulfonic acid, sodium salt,
HO(CH₂)₃SO₃Na
III) 2(methyl)-2-(sodium salt sulfonic acid) propylene glycol, 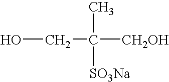
IV) N-(2-sodium salt sulfonic acid) ethylene diamine, and
H₂N(CH₂)₂NH(CH₂)₂SO₃Na
V) N-(2-acetamide)-2-amino athane sulfonic acid, sodium salt.

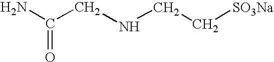

D. Hydrophobic Material

The term “hydrophobic material” as used herein means a compound or mixture of compounds containing one or more substantially non-polar organic moieties. The hydrophobic materials are substantially water insoluble and generally contain at least one group capable of being esterified or transesterified, such as a monocarboxylic acid group, a monocarboxylic acid ester group, or a hydroxyl group. The terms “monocarboxylic acid group” and “monocarboxylic acid ester group” as used herein means that carboxylic acid moieties present in the hydrophobic material are monoacids. Generally, the hydrophobic materials used herein are non-phthalic acid derived materials.

Any hydrophobic compound as above characterized can be employed, such as carboxylic acids (especially fatty acids), lower alkanol esters of carboxylic acids (especially fatty acid methyl esters), fatty acid alkanolamides, triglycerides (especially fats and oils), alkyl alcohols (for example, those containing from 4 to 18 carbon atoms per molecule), and the like. Mixtures of different hydrophobic compounds can be employed if desired.

Examples of fatty acids include caproic, caprylic, capric, lauric, myristic, palmitic, stearic, oleic, linoleic, linolenic, ricinoleic, and mixtures thereof. Another suitable acid is 2-ethylhexanoic acid.

Examples of fatty acid methyl esters include methyl caproate, methyl caprylate, methyl caprate, methyl laurate, methyl myristate, methyl palmitate, methyl oleate, methyl stearate, methyl linoleate, methyl linolenate, and mixtures thereof.

Examples of fatty alkanolamides include tall oil fatty acid diethanolamide, lauric acid diethanolamide, and oleic acid monoethanolamide.

Examples of alkyl alcohols include decyl alcohol, oleyl alcohol, cetyl alcohol, isodecyl alcohol, tridecyl alcohol, lauryl alcohol, mixed C₁₂-C₁₄ alcohol, and mixtures thereof.

Examples of commercially available, relatively low cost fats and oils include castor oil, coconut (including cochin) oil, corn oil, cottonseed oil, linseed oil, olive oil, palm oil, palm kernel oil, peanut oil, soybean oil, sunflower oil, tall oil, tallow, and mixtures thereof.

E. Inter-Esterification Catalysts

As previously indicated, although no catalyst is required, the inter-esterification reaction may preferably be performed using any suitable esterification catalyst known to those of ordinary skill in the art. Typically, the catalyst is present from about 0.001 to about 0.1 percent by weight, based on the total weight of all reactants. Suitable inter-esterification catalysts may include, for example, acids such as sulfuric acid, phosphoric acid, para-toluene sulfonic acid; organotin compounds such dibutyl tin-(IV) dilaurate; and titanium compounds such as titanium (IV) isoproproxide. Tyzor®TE, Tyzor®LA, Tyzor®TPT and their equivalents are suitable. Tyzor®TE is believed to comprise diisopropyl di-triethanolamino titanate, with triethanolamine as a chelating agent.

The above inter-esterification reactants may be combined in any order to produce the aromatic polyester polyol inter-esterification reaction product of the invention. The aromatic polyester polyol inter-esterification reaction product is preferably prepared directly from starting reactants which include the previously described phthalic acid based material, hydroxylated material, sulfonated compound and optional hydrophobic material. However, and somewhat less preferably, the aromatic polyester polyol inter-esterification reaction product of the present invention may be finally prepared from a starting material which is itself the reaction product of a phthalic acid based material and a hydroxylated material; i.e. a pre-formed polyester polyol. In such instances, the pre-formed aromatic polyester polyol is then reacted, i.e. inter-esterified, with the sulfonated compound, and optionally with the hydrophobic material, if desired, to form the final aromatic polyester polyol inter-esterification reaction product. Examples of suitable pre-formed aromatic polyester polyols include those commercially available from Oxid under the designation Terol, from Invista under the tradename Terate, and from Stepan Company under the tradename StepanPol.

### Polyol-Based Compositions

Another embodiment of present invention comprises polyol-based compositions including
(A) a polyol component comprising:
   (I) from about 20 to about 100 percent by weight of an aromatic polyester polyol comprising the inter-esterification product of reactants comprising:
      (a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
      (b) from about 10 to about 70 percent by weight of at least one hydroxylated material having a functionality of at least 2; and
      (c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups and mixtures thereof; and
   (II) from 0 to about 80 percent by weight of a polyether polyol; and
(B) from about 0.1 to about 35 parts per hundred of polyol component, of a blowing agent.

A. Polyol Component

The aromatic polyester polyol inter-esterification reaction product previously described can be used as the sole polyol in the polyol component of the polyol-based composition, or it can be mixed with a polyether polyol. Accordingly, the amount of the aromatic polyester polyol reaction product in the polyol component is from about 20 to about 100 percent by weight, based on the total weight of the polyol component. The amount of the aromatic polyester polyol reaction product utilized in the polyol component is determined by the requirements of the application and the physical properties required of the resulting foam. For example, in applications involving isocyanate indexes near 300, e.g., preparing typical polyisocyanurate foams, the aromatic polyester polyol reaction product advantageously may be the dominant or sole polyol in the polyol component.

The polyol component can also include a polyether polyol. An exemplary polyether polyol is a polyoxyalkylene polyether polyol having a functionality from 2 to 8. Polyoxyalkylene polyether polyols useful in the polyol component include but are not limited to any one or more of polyoxyalkylated sucrose, polyoxyalkylated glycerol, and polyoxyalkylene glycols.

As is well-known to those skilled in the art, polyoxyalkylene polyether polyols can be prepared via anionic or cationic polymerization of starting materials such as one or more alkylene oxides, preferably containing from 2 to 4 carbons in the alkylene radical. Any suitable alkylene oxide may be used, and examples include 1,3-propylene oxide, 1,2-butylene oxide, 2,3-butylene oxide, amylene oxides, styrene oxide, and, preferably, ethylene oxide and 1,2-propylene oxide and mixtures thereof. The polyoxyalkylene polyether polyols alternatively may be polymerized from other starting materials such as tetrahydrofuran, alkylene oxide-tetrahydrofuran mixtures, or epihalohydrins such as epichlorohydrin. The polyoxyalkylene polyether polyols may have either primary or secondary hydroxyl groups.

Polyoxyalkylene polyether polyols can be produced by anionic polymerization of such starting materials with alkali hydroxides as catalysts, including sodium hydroxide or potassium hydroxide, or with alkali alcoholates as catalysts, including sodium methylate, sodium or potassium ethylate, or potassium isopropylate, and, in addition to the catalysts, at least one initiator molecule containing from 2 to 8, and preferably from 3 to 8, reactive hydrogens. Polyoxyalkylene polyether polyols also can be produced by cationic polymerization of such starting materials with Lewis acids as catalysts, including antimony pentachloride or boron trifluoride etherate, or with bleaching earth as catalyst.

Included among the polyoxyalkylene polyether polyols are polyoxyalkylene glycols, such as polyoxyethylene glycol, polyoxypropylene glycol, polyoxybutylene glycol, and polytetramethylene glycol; block copolymers, such as combinations of polyoxypropylene and polyoxyethylene glycols, or poly-1,2-oxybutylene and polyoxyethylene glycols, or poly-1,4-tetramethylene and polyoxyethylene glycols; and copolymer glycols prepared from blends or sequential addition of two or more alkylene oxides. The polyoxyalkylene polyether polyols may be prepared by any known process.

Other types of polyols may optionally be used in combination with the polyol component. Examples of other types of polyols include: thioether polyols; polyester amides, polyacetals, and aliphatic polycarbonates containing hydroxyl groups; amine terminated polyoxyalkylene polyethers; non-aromatic polyester polyols, graft dispersion polyols, and, preferably, polyester polyether polyols. Mixtures of two or more of the aforesaid polyols can be used so long as the combination produces a polyol component having a suitable average hydroxyl number

B. Blowing Agent

The polyol-based compositions of the present invention include from about 0.1 to about 35 parts (by weight) per hundred of polyol component, of a blowing agent. Exemplary preferred blowing agents include C₄-C₇ hydrocarbons, water and mixtures thereof, as well as hydrofluorocarbons and perfluorinated hydrocarbons. Such blowing agents may be used as the sole blowing agent, or alternatively, lesser amounts of auxiliary blowing agents may also be employed.

Thus, in one embodiment, the primary blowing agent is an aliphatic or cycloaliphatic C₄-C₇ hydrocarbon blowing agent. Such hydrocarbons have a boiling point of 70° C. or less at 1 atmosphere, and preferably have a boiling point of 50° C. or less at 1 atmosphere. The hydrocarbon blowing agent is physically active and has a boiling point sufficiently low so as to become gaseous and evaporate at the exothermic temperatures caused by the reaction between an isocyanate and polyol. The vaporizing hydrocarbon blowing agent provides foaming action within the resulting polyurethane/polyisocyanurate matrix. Hydrocarbon blowing agents consist exclusively of carbon and hydrogen and are therefore non-halogenated by definition. Exemplary C₄-C₇ hydrocarbon blowing agents include, alone or in combination: linear or branched alkanes, such as butane, isobutane, 2,3-dimethylbutane, n-pentane, isopentane, technical-grade pentane mixtures, n-hexane, isohexane, n-heptane, isoheptane, or mixtures thereof; alkenes, such as 1-pentene, 2-methylbutene, 3-methylbutene, 1-hexene, or mixtures thereof; and cycloalkanes, such as cyclobutane, cyclopentane, cyclohexane or mixtures thereof. Preferred C₄-C₇ hydrocarbon blowing agents include cyclopentane, n-pentane, isopentane, and mixtures thereof.

When the primary blowing agent is an C₄-C₇ hydrocarbon, the amount of such hydrocarbon blowing agent in the polyol-based compositions of the present invention is generally from about 5 to about 35 parts (by weight) per hundred of polyol component. More preferably, the amount of such hydrocarbon blowing agent is from about 15 to about 30 parts per hundred of polyol component. Most preferably, the amount of such hydrocarbon blowing agent is from about 5 to about 25 parts per hundred of polyol component.

Polyol-based compositions of the present invention which include a C₄-C₇ hydrocarbon primary blowing agent typically form emulsions that are stable for a surprisingly long period of time, for example, on the order of 48 hours or more. In polyol-based compositions of the prior art, i.e., compositions including C₄-C₇ hydrocarbon blowing agents and aromatic polyester polyols not made with an inter-esterified sulfonated compound, long term composition stability oftentimes could only be achieved, if at all, via the inclusion of about 1 to 20 parts per hundred polyol, of a EO/PO/BO or similar nonionic surfactant. Not only are such nonionic surfactants expensive, the use of such surfactants is also known to detract from the physical properties of the final polyisocyanurate foams. In contrast, the polyol-based compositions of the present invention which include a C₄-C₇ hydrocarbon primary blowing agent are typically sufficiently stable that for the majority of applications, there is no need to employ these expensive and physical-property detracting surfactants.

Other blowing agents may of course be used in conjunction with C₄-C₇ hydrocarbon blowing agents. Such auxiliary blowing agents may be divided into the classes of: (1) chemically active blowing agents, which chemically react with isocyanate or other formulation ingredients to produce a gas that subsequently is liberated, thereby generating foaming action; and (2) physically active blowing agents which are gaseous at or below the exothermic foaming temperatures, thereby providing a blowing gas without the need to chemically react with the foam ingredients. Included within the meaning of physically active blowing agents are decomposition-type materials that are thermally unstable and which decompose at elevated temperatures, releasing a gas.

When C₄-C₇ hydrocarbons are employed as the primary blowing agent, lesser amounts of water may also be employed. Water can be classed and used as a chemically active blowing agent because water reacts with isocyanate to produce and liberate CO₂, the actual resulting blowing agent. As is known to one skilled in the art, because water consumes isocyanate groups, using water as a chemically active blowing agent may require adding an equivalent molar excess of isocyanate to compensate for the amount of isocyanates consumed by the water. As is known to one skilled in the art, a minor quantity of water may be found in polyols as a byproduct of reaction, and such water may act as a lone auxiliary chemically active blowing agent. Optionally, however, water may be added to the polyol-based compositions of the invention, in an amount of from about 0.05 to about 5 parts per hundred of polyol, and preferably from about 0.25 to about 1.0 parts per hundred of polyol. Other auxiliary chemically active blowing agents may of course be employed instead of, or in addition to, water. Auxiliary physically active blowing agents also may be employed instead of, or in addition to, auxiliary chemically active blowing agents.

Preferred auxiliary chemically active blowing agents are those which react with isocyanate to liberate a gas such as CO₂. Suitable chemically active blowing agents include, but are not limited to, water, mono- and polycarboxylic acids having a molecular weight of from 46 to 300, salts of such polycarboxylic acids, and tertiary alcohols.

Organic carboxylic acids used as auxiliary chemically active blowing agents advantageously include aliphatic mono- and polycarboxylic acids, for example, dicarboxylic acids. Also suitable, however, are other organic mono- and polycarboxylic acids. The organic carboxylic acids may, if desired, also contain olefinically unsaturated groups, and/or may contain other substituents that can be either isocyanate-inert or isocyanate-reactive under polyisocyanate addition reaction conditions. Examples of chemically inert substituents include but are not limited to halogen atoms, such as fluorine or chlorine, and alkyl groups, such as methyl or ethyl. Organic carboxylic acids substituted with an isocyanate-inert group preferably contain at least one further group that is isocyanate-reactive, for example a mercapto group, a primary and/or secondary amino group, or a primary and/or secondary hydroxyl group. The organic carboxylic acids useful as auxiliary chemically active blowing agents generally have a molecular weight of from about 46 to about 300.

Suitable carboxylic acids are thus substituted or unsubstituted monocarboxylic acids, including but not limited to formic acid, acetic acid, propionic acid, 2-chloropropionic acid, 3-chloropropionic acid, 2,2-dichloropropionic acid, hexanoic acid, 2-ethylhexanoic acid, cyclohexanecarboxylic acid, dodecanoic acid, palmitic acid, stearic acid, oleic acid, 3-mercaptopropionic acid, glycolic acid, 3-hydroxypropionic acid, lacetic acid, ricinoleic acid, 2-aminopropionic acid, benzoic acid, 4-methylbenzoic acid, salicylic acid and anthranilic acid. Suitable carboxylic acids are also substituted or unsubstituted polycarboxylic acids, including but not limited to oxalic acid, malonic acid, succinic acid, fumaric acid, maleic acid, glutaric acid, adipic acid, sebacic acid, dodecanedioic acid, tartaric acid, phthalic acid, isophthalic acid and citric acid.

Organic carboxylic acid salts can also be used as auxiliary chemically active blowing agents. Carboxylic acid salts are made using known methods, and typically are formed by reacting a carboxylic acid with a tertiary amine, including but not limited to triethylamine, dimethylbenzylamine, diethylbenzylamine, triethylenediamine, or hydrazine. Exemplary carboxylic acid salts are tertiary amine salts of formic acid. Organic carboxylic acid salts may be added as such or may be formed in situ, for example by reacting a tertiary amine with a carboxylic acid contained in the polyol-based composition.

Tertiary alcohols can also be used as auxiliary chemically active blowing agents. Tertiary alcohols are made using known methods, and typically are formed by reacting an acyl halide with an excess of Grignard reagent, followed by hydrolysis of the reaction product. Suitable tertiary alcohols include but are not limited to t-butyl alcohol and t-pentyl alcohol.

Combinations of any of the aforementioned auxiliary chemically active blowing agents may be employed. Exemplary chemically active blowing agent combinations include mixtures of some or all of formic acid, formic acid salts, and water.

Auxiliary physically active blowing agents for use in combination with the hydrocarbon blowing agents include materials that boil at or below the exothermic foaming temperature. Such physically active blowing agents preferably have a boiling point of 50° C. or less at 1 atmosphere. The most preferred physically active blowing agents are those having an ozone depletion potential of 0.05 or less. Examples of auxiliary physically active blowing agents include but are not limited to dialkyl ethers, cycloalkylene ethers and ketones; hydrochlorofluorocarbons (HCFCs); hydrofluorocarbons (HFCs); perfluorinated hydrocarbons; fluorinated ethers; and decomposition-type materials.

Any hydrochlorofluorocarbon may be used as a primary or auxiliary blowing agent in the present invention. Exemplary hydrochlorofluorocarbon blowing agents include 1-chloro-1,2-difluoroethane; 1-chloro-2,2-difluoroethane (142a); 1-chloro-1,1-difluoroethane (142b); 1,1-dichloro-1-fluoroethane (141b); 1-chloro-1,1,2-trifluoroethane; 1-chloro-1,2,2-trifluoroethane; 1,1-dichloro-1,2-difluoroethane; 1-chloro-1,1,2,2-tetrafluoroethane (124a); 1-chloro-1,2,2,2-tetrafluoroethane (124); 1,1-dichloro-1,2,2-trifluoroethane; 1,1-dichloro-2,2,2-trifluoroethane (123); and 1,2-dichloro-1,1,2-trifluoroethane (123a); monochlorodifluoromethane (HCFC-22); 1-chloro-2,2,2-trifluoroethane (HCFC-133a); gemchlorofluoroethylene (R-1131a); chloroheptafluoropropane (HCFC-217); chlorodifluoroethylene (HCFC-1122); and transchlorofluoroethylene (HCFC-1131).

Other exemplary hydrofluorocarbons, perfluorinated hydrocarbons, and fluorinated ethers include difluoromethane (HFC-32); 1,1,1,2-tetrafluoroethane (HFC-134a); 1,1,2,2-tetrafluoroethane (HFC-134); 1,1-difluoroethane (HFC-152a); 1,2-difluoroethane (HFC-152), trifluoromethane; heptafluoropropane; 1,1,1-trifluoroethane; 1,1,2-trifluoroethane; 1,1,1,2,2-pentafluoropropane; 1,1,1,3,3-pentafluoropropane; 1,1,1,3-tetrafluoropropane; 1,1,2,3,3-pentafluoropropane; 1,1,1,3,3-pentafluoro-n-butane; hexafluorocyclopropane (C-216); octafluorocyclobutane (C-318); perfluorotetrahydrofuran; perfluoroalkyl tetrahydrofurans; perfluorofuran; perfluoro-propane, -butane, -cyclobutane, -pentane, -cyclopentane, -hexane, -cyclohexane, -heptane, and -octane; perfluorodiethyl ether; perfluorodipropyl ether; and perfluoroethyl propyl ether.

Additional useful physically active blowing agents include decomposition-type materials that are thermally unstable and which decompose at elevated temperatures, releasing a gas. Examples of decomposition-type materials that release a gas upon undergoing thermal decomposition include but are not limited to pecan flour, amine/carbon dioxide complexes, and alkyl alkanoate compounds, especially methyl and ethyl formates.

In certain embodiments of the present polyol-based composition, the sole or primary blowing agent is water. Water is the preferred blowing agent in several spray foam applications, and in a typical commercial blowing application, the preferred mixing ratio of isocyanate to polyol is 1:1 by volume. However, in isocyanate applications, water will react with the isocyanate, as each mole of water will consume two moles of isocyanate and generate CO₂ as a byproduct. In order to maintain the preferred 1:1 by volume ratio, the hydroxyl number of the aromatic polyester polyol must be kept at a low value, such as below 110 or less. However, any aromatic polyester polyol with a 100 hydroxyl value, with or without a hydrophobe, will have poor water solubility. See example 20, below. However, the sulfonic acid compound containing aromatic polyester polyols of the present invention have excellent water solubility and excellent solution stability. See example 21, below. Therefore, the use of the sulfonated aromatic polyster polyols of the present invention in water blown applications increases the water solubility of the polyol, making it much more attractive for use in water blown applications.

The amount of such water blowing agent in the polyol-based compositions of the present invention is from about 0.1 to about 30 parts (by weight) per hundred of polyol component. More preferably, the amount of water is from about 0.5 to about 20 parts per hundred of polyol component. Most preferably, the amount of water blowing agent is from about 1.0 to about 10 parts per hundred of polyol component. In certain embodiments of the present polyol-based composition wherein water is used as the primary blowing agent, it may be useful to employ small quantities of added CO₂, such as is taught in Yoshiyuki Ohnuma, Junichiro Mori, Supercritical CO₂ Assisted Water Blown Spray Foams, POLYURETHANES EXPO 2003, Oct. 1-3, 2003; and U.S. Patent Application Publication US 2004/0054022, the disclosures of which are hereby incorporated by reference in the entireties.

Polyol-based compositions of the present invention which include water as the sole or primary blowing agent are likewise typically solutions or emulsions having surprisingly long-lasting stability. Accordingly, such polyol-based compositions of the present invention are likewise typically sufficiently stable for the majority of applications requiring polyol-based compositions or b-side compositions with long-term stability properties. For the aromatic polyester polyol of such polyol-based compositions, it may be especially advantageous to employ one or more hydrophobic materials as an inter-esterification reactant.

In still other embodiments, the polyol-based compositions of the present invention may employ as the sole or primary blowing agent, any combination of the above-referenced auxiliary blowing agents. For example, the blowing agent of the polyol-based compositions of the present invention may be one or more hydrochlorofluorocarbon (HCFC), hydrofluorocarbon (HFC), or perfluorinated hydrocarbon.

C. Other Optional Ingredients.

Optionally preferred ingredients for the include cell-stabilizing surfactants, flame retardants, catalysts, and nonionic surfactants.

1. Cell-Stabilizing Surfactants

The polyol-based compositions of the present invention optionally contain cell-stabilizing surfactants. Examples of cell-stabilizing surfactants include but are not limited to Pelron Pelsil 9346; Dabco DC-5098 silicone surfactant, available commercially from Air Products and Chemicals, Inc.; Tegostab B-8479 and B-8469 silicone surfactants, available commercially from Goldschmidt Chemical Corp.; and Vorasurf 504, a non-silicone surfactant available from Dow Chemical Company. Cell-stabilizing surfactants, if employed, are added to the polyol-based composition in an amount of from about 0.5 to about 5 parts per hundred polyol, and preferably from about 1 to about 3 parts per hundred polyol.

2. Flame Retardants

Flame retardant additives may be added to achieve foams having a particular flame retardancy classification. Preferred flame retardants are solid or liquid compounds containing one or more of the elements phosphorus, chlorine, bromine, and boron. Examples of flame retardants include but are not limited to tris-(2-chloro isopropyl) phosphate, tetrakis-(2-chloro ethyl)ethylene diphosphate, tris-(beta-chloro ethyl) phosphate, and tris-(2,3-dibromo propyl) phosphate. Tris-(2-chloro isopropyl) phosphate is a particularly preferred flame retardant. Also preferred are brominated phthalic esters from Great Lakes Chemical or RB-79 from Albemarle Corporation. Flame retardants, if employed, are added to the polyol-based composition in an amount of from about 2 to about 50 parts per hundred polyol, and preferably from about 5 to about 25 parts per hundred polyol. The amount of flame retardant based on the weight of all foaming ingredients is from about 1 to about 25 percent by weight, and preferably from about 2 to about 15 percent by weight.

3. Catalysts

The polyol-based compositions of the invention optionally contain catalysts to accelerate the reaction with the polyisocyanate. Suitable catalysts are known in the art and include but are not limited to salts of organic carboxylic acids, for example sodium salts, ammonium salts, and preferably potassium salts. Examples include trimethyl-2-hydroxypropyl ammonium formate, trimethyl-2-hydroxypropyl ammonium octanoate, potassium formate, potassium octanoate and potassium acetate. Tertiary amines also promote urethane linkage formation, and include but are not limited to triethylamine, 3-methoxypropyldimethylamine, triethylenediamine, pentamethyldiethylenetriamine, and bis(dimethylaminopropyl)urea. Other exemplary catalysts include potassium 2-ethylhexanoate, available commercially from Air Products and Chemicals under the tradename Dabco K-15-Catalyst; pentamethyldiethylenetriamine, available commercially from Air Products and Chemicals under the tradename Polycat 5 Catalyst; and dimethylcyclohexylamine, available commercially from Air Products and Chemicals under the tradename Polycat 8 Catalyst. Catalysts, if employed, are added to the polyol-based composition in an amount of from about 0.1 to about 10 parts per hundred polyol, and preferably from about 0.1 to about 8 parts per hundred polyol.

### Polyurethane and Polyisocyanurate Foams

The above-described polyol-based compositions may be formulated, and combined in various proportions with a polyisocyanate, according to well-known methods, to form a polyurethane or polyisocyanurate foam. For example, in applications involving isocyanate indexes near 250, e.g., preparing typical polyisocyanurate foams, the aromatic polyester polyol inter-esterification reaction product advantageously is the dominant or sole polyol in the polyol component of the polyol-based composition.

All documents, e.g., patents and journal articles, cited above or below are hereby incorporated by reference in their entirety.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

In a three-neck 5-liter pot, there was charged 265 grams of ethylene glycol, 1,346 grams of diethylene glycol, 163 grams of triethylene glycol, 643 grams of a mixture of about 80% tetraethylene glycol and 20% triethylene glycol, 295 grams of dimethyl-5-sulfoisophthalate sodium salt, 911.1 grams of phthalic anhydride, 1114.5 grams of BACA, and about 4 grams of Tyzor®TE. BACA is a residue from the manufacture of terephthalic acid. BACA is a somewhat variable feedstock containing terephthalic acid in the range of about 62-80%; toluic acid and other materials in the range of about 0-8%; and water in the range of about 20-30%.

The pot was attached to a distillation column packed with stainless steel mesh wire. The pot was then slowly heated up to 232° C. by temperature controller with vacuum set @ 200 mm Hg. The reflux ratio was set @ 3 to 1, so that only the methanol and water as by products of reaction were removed.

Throughout the reaction, 63.73 grams of methanol and 601 grams of water was collected. Once the acid number of polyol was less than 3, the reaction was stopped. The finished polyol after filtration had hydroxyl value of 270, viscosity of 14,720 cps @ 25° C. (measured using a Brookfield viscometer), acid value of 0.70, and a water content of 0.15%.

This polyol was labeled as DS-753.

### Example 2

In a three-neck 5-liter pot, there was charged 1288 grams of diethylene glycol, 300.1 grams of triethylene glycol, 963.4 grams of a mixture of about 80% tetraethylene glycol and 20% triethylene glycol, 179.7 grams of 5-sulfoisophthalic acid, sodium salt, 533.2 grams of phthalic anhydride, 1025.3 grams of terephthalic acid, and about 4 grams of Tyzor®TE.

The pot was attached to a distillation column packed with stainless steel mesh wire. The pot was then slowly heated up to 232° C. by temperature controller with vacuum set @ 200 mm Hg. The reflux ratio was set @ 3 to 1, so that only the water as by product of reaction was removed.

Throughout the reaction, about 290 grams of water was collected. Once the acid value of polyol was less than 3.0, the reaction was stopped. The finished polyol had hydroxyl value of 208, viscosity of 14,720 cps @ 25° C. (measured using a Brookfield viscometer), and acid value of 0.70.

This polyol was labeled as DS-783.

The hydroxyl number of DS-783 was then increased to 250 by adding diethylene glycol. The polyol thus formed was re-labeled as DS-783-1. The viscosity of this polyol is 7,360 cps @ 25° C., measured using a Brookfield viscometer.

### Example 3

In a three-neck 5-liter pot, there was charged 1288 grams of diethylene glycol, 949 grams of triethylene glycol, 482 grams of a mixture of about 80% tetraethylene glycol and 20% triethylene glycol, 158 grams of dimethyl-5-sulfoisophthalate sodium salt, 1915 grams of virgin polyethylene terephthalate in the form of ground chips, and about 4 grams of Tyzor®TE.

The pot was attached to a distillation column packed with stainless steel mesh wire. The pot was then slowly heated up to 232° C. by temperature controller with vacuum set @ 100 mm Hg. The reflux ratio was set @ 4 to 1, so that only the methanol and ethylene glycol as by products of reaction were removed.

Once about 34.13 grams of methanol and 598.4 grams of ethylene glycol should be collected, the reaction is terminated. The finished polyol had hydroxyl value of 242, viscosity of 8,320 cps @ 25° C. (measured using a Brookfield viscometer), and acid value of 0.80. This polyol had water solubility of 70 parts per hundred part of polyol (PPHP).

This polyol was labeled as DS-909.

### Example 4

In a three-neck 12-liter pot, there was charged 7399 grams of diethylene glycol, 549 grams of triethylene glycol, 4760.9 grams of BACA (described previously), and about 4 grams of Tyzor®TE.

The pot was slowly heated up to 232° C. by temperature controller with vacuum set @ 200 mm Hg. The reflux ratio was set @ 3 to 1, so that only water as by product of reaction was removed.

After about 1980 grams of water was collected, the reaction mixture was cooled down to about 150° C. The intermediate was then filtered through the filter press to remove the dirt from the reaction mixture.

The remaining intermediate was charged back to a clean pot. Additionally, there was then charged to the pot 897.5 grams of 5-sulfoisophthalic acid, sodium salt, 3742.4 grams of phthalic anhydride and 3159.4 grams of a mixture of about 80% tetraethylene glycol and 20% triethylene glycol.

The pot was slowly heated up to 232° C. by temperature controller with vacuum set @ 200 mm Hg. The reflux ratio is set @ 3 to 1, so that only water as by product of reaction was removed.

An additional 120 grams of water was collected. Once the acid number of polyol was less than 3, the reaction was stopped. The finished polyol had a hydroxyl value of 250, viscosity of 9,120 cps @ 25° C. (measured using a Brookfield viscometer), and acid value of 0.80.

This polyol was labeled as DS-912.

### Example 5

In a three-neck 5-liter pot, there was charged 1218 grams of diethylene glycol, 140.1 grams of triethylene glycol, 588.8 grams of a mixture of about 80% tetraethylene glycol and 20% triethylene glycol, 239.6 grams of ethylene glycol, 247.125 grams of 5-sulfoisophthalic acid, sodium salt, 817.3 grams of phthalic anhydride, 1045.1 grams of BACA (described previously), and about 4 grams of Tyzor®TE.

The pot was slowly heated up to 232° C. by temperature controller with vacuum set @ 200 mm Hg. The reflux ratio is set @ 3 to 1, so that only water as by product of reaction was removed.

About 546 grams water was collected. Once the acid number was less than 3, the reaction was stopped. The finished polyol after filtration had hydroxyl value of 234, viscosity of 22,800 cps @ 25° C. (measured using a Brookfield viscometer), and acid value of 0.50.

This polyol was labeled as DS-916.

### Example 6

In a three-neck 5-liter pot, there was charged 974.3 grams of triethylene glycol, 1540 grams of a mixture of about 20% triethylene glycol, 60% tetraethylene glycol and 20% pentaethylene glycol, 137 grams of 5-sulfoisophthalate acid sodium salt, 1721 grams of virgin polyethylene terephthalate in the form of ground chips, 666 grams of crude corn oil, and about 4 grams of Tyzor®TE.

The pot was attached to a distillation column packed with stainless steel mesh wire. The pot was slowly heated up to 232° C. by temperature controller with vacuum set @100 mm Hg. The reflux ratio was set @ 4 to 1, so that only the water and ethylene glycol as by products of reaction were removed.

Once about 18.39 grams of water and 537.8 grams of ethylene glycol were collected, the reaction was terminated.

The finished polyol has hydroxyl value of 77 and viscosity of 9,920 cps @ 25° C., measured using a Brookfield viscometer.

The hydroxyl value of polyol was raised to 105 by adding diethylene glycol. The final viscosity of the polyol was 6.720 cps @ 25° C., measured using a Brookfield viscometer. The water solubility of this polyol was about 100 parts per hundred part of polyol (PPHP).

This polyol was labeled as DS-1017.

### Example 7

In a three-neck 5-liter pot, there was charged 924.1 grams of triethylene glycol, 1588.2 grams of a mixture of about 20% triethylene glycol, 60% tetraethylene glycol and 20% pentaethylene glycol), 77.25 grams of 5-sulfoisophthalate acid sodium salt, 1755.2 grams of virgin polyethylene terephthalate in the form of ground chips, 713.5 grams of crude corn oil, and about 4 grams of Tyzor®TE.

The pot was attached to a distillation column packed with stainless steel mesh wire. The pot was slowly heated up to 232° C. by temperature controller with vacuum set @ 100 mm Hg. The reflux ratio was set @ 4 to 1, so that only the water and ethylene glycol as by products of reaction were removed.

Once about 10.37 grams of water and 548.5 grams of ethylene glycol were collected, the reaction was terminated.

The finished polyol had hydroxyl value of 108 and viscosity of 5,560 cps @ 25° C., measured using a Brookfield viscometer.

The water solubility of this polyol was about 100 parts per hundred part of polyol (PPHP).

This polyol was labeled as DS-1027.

### Example 8

In a three-neck 5-liter pot, was charged, 1456 rams of a mixture of about 80% tetraethylene glycol and 20% triethylene glycol, 1544 grams of vigin polyethylene terephthalate in the form of ground chips, 468 grams of crude corn oil, and about 4 grams of Tyzor®TE. For this comparative example, no low molecular weight sulfonated compound was used.

The pot was attached to a distillation column packed with stainless steel mesh wire. The pot is slowly heated up to 232° C. by temperature controller with vacuum set @ 100 mm Hg. The reflux ratio is set @ 4 to 1, so that only ethylene glycol as by product of reaction was removed.

Once about 482.5 grams of ethylene glycol was collected, the reaction was stopped. The finished polyol had hydroxyl value of 118 and viscosity of 2,160 cps @ 25° C., measured using a Brookfield viscometer.

The water solubility of this polyol was 4 parts per hundred part of polyol (PPHP).

This polyol was labeled Comparative Polyol No. 1.

### Examples 9-16

A number of polyol-based compositions were prepared by combining one or more aromatic polyester polyols with a measured amount of normal pentane. In each case, the respective polyol-based composition was first thoroughly agitated, then allowed to separate. Table I shows the emulsion stability measured for these polyol-based compositions. Examples 9 and 10 make use of the inventive polyol of Example 1 (DS-753). Comparative Examples 11-16 make use of commercially available aromatic polyester polyols.

TABLE I

| | | Polyol | P9346 | | |
|---|---|---|---|---|---|
| Exam- | | weight | Surfactant | N-Pentane | Emulsion |
| ple | Polyol | (pphp) | (pphp) | (pphp) | Break Time |
| 9 | DS-753 | 100 | 2 | 20 | 41 days |
| 10 | DS-753 | 50 | 2 | 20 | 7 hours |
| | Terol ® 563 | 50 | | | |
| 11 | Terol ® 563 | 100 | 2 | 20 | 15 minutes |
| 12 | Terol ® 563 | 97 | 2 | 20 | 6 hours, |
| | IL-2769 | 3 | | | 40 minutes |
| 13 | Terol ® 588R | 100 | 2 | 20 | 18 minutes |
| 14 | Terol ® 250 | 100 | 2 | 20 | 20 minutes |
| 15 | Terate ® 3522 | 100 | 2 | 20 | 35 minutes |
| 16 | PS-2352 | 100 | 2 | 20 | 6 hours |

Each of the above polyol-based compositions included 2 parts per hundred polyol of P9346, a conventional silicone-based cell stabilizing surfactant available from Pelron Corporation. Terol® 563, Terol® 588R and Terol® 250 are aromatic polyester polyols manufactured by Oxid, L.P. These polyols are manufactured by inter-esterifying at least one phthalic acid based material with at least one hydroxylated material having a functionality of at least 2, with Terol® 588R also including one hydrophobic material as an inter-esterification reactant. IL-2769 is a surfactant available from Imperial Chemical Industries. Terate® 3522 is an aromatic polyester polyol manufactured by KoSa and is believed to be based on DMT process residues. PS-2352 is an aromatic polyester polyol manufactured by Stepan Company under the trade name Stepanpol.® PS-2352 is believed to be phthalic anhydride/diethylene glycol adduct that is inter-esterified with soybean oil.

### Example 17

Exemplary polyol made according to the present invention, DS 753, was formulated into a polyol-based composition including a normal pentane blowing agent. This polyol-based composition was then reacted with a suitable polyisocyanate to form a hydrocarbon-blown polyisocyanurate foam. Table II below shows the various additives and other ingredients used to formulate the polyol-based composition, as well as the physical properties of the composition and the blown polyisocyanurate foam prepared therefrom. As demonstrated in Table II, hydrocarbon blown foam having acceptable physical properties can be prepared using an aromatic polyester polyol that includes an inter-esterified low molecular weight sulfonated compound.

TABLE II

| | | |
|---|---|---|
| Component | Name | Example 17 |

Polyol-based Composition: (parts by weight)

| | | |
|---|---|---|
| Polyol 1 | DS 753 | 100.00 |
| F.R. Additive | Antiblaze 80 | 15.00 |
| Surfactant | Pel-Sil 9346 | 3.00 |
| Catalyst 1 | Polycat 5 | 0.25 |
| Catalyst 2 | Polycat 46 | 2.00 |
| Catalyst 3 | Dabco K15 | 1.00 |
| Water | | 0.30 |
| Blowing Agent | n-Pentane | 20.00 |
| Total B-side | | 141.55 |
| Index on B-side | | 2.500 |
| Isocyanate | M 489 | 183.86 |
| A:B Ratio | | 1.299 |
| % Blowing agent in foam | | 6.30 |
| Reactivity and Form Properties: | | |
| Cream @ 20° C. (sec.) | | 25 |
| String gel @ 20° C. (sec.) | | 55 |
| Tackfree @ 20° C. (sec.) | | 70 |
| Core Density (pcf) | | 1.87 |
| Compresive Strength (psi) | | |
| Yield-Parallel | | 36.2 |
| Yield-Perpendicular | | 12.7 |
| Dimensional Stability (% ΔV) | | |
| Day 3 | | |
| −20° F. | | 0.11 |
| 158° F. & 97% Rel. Humidity | | 7.19 |
| 158° F. | | 1.96 |
| % Closed Cell Content | | 96.30 |
| % Open Cell Content | | 3.70 |

In Table II above, Antiblaze 80 is a flame retardant additive available from Albemarle Chemical Corporation. Pel-Sil 9346 is a silicone-based cell stabilizing surfactant from Pelron. Polycat 5 is pentamethyldiethylenetriamine, available commercially from Air Products and Chemicals. Polycat 46 is potassium acetate in ethylene glycol, also available commercially from Air Products and Chemicals. Dabco K15 is a potassium salt in a glycol, also available commercially from Air Products and Chemicals. M 489 is Mondur® 489, a polymeric diphenyl-methane diisocyanate available from Bayer.

### Examples 18 & 19

Table III, below, compares the physical properties of another exemplary polyol made according to the present invention, DS 783-1, with those of Terol® 588R, a commercially available polyol.

TABLE III

| Sample | OH No. | Viscosity (cp) | Acid No. | % Water |
|---|---|---|---|---|
| DS 783-1 | 250 | 7360 | 2.1 | 0.10 |
| Terol ® 588R | 242 | 3440 | 1.4 | 0.08 |

These two aromatic polyester polyols were formulated into polyol-based compositions including a normal pentane blowing agent. These polyol-based compositions were then reacted with a suitable polyisocyanate to form hydrocarbon-blown polyisocyanurate foams. Table IV below shows the various additives and other ingredients used to formulate the polyol-based compositions, as well as the physical properties of the compositions and the blown polyisocyanurate foams prepared therefrom. As demonstrated in Table IV, hydrocarbon blown foams having comparable physical properties can prepared using aromatic polyester polyols that include inter-esterified low molecular weight sulfonated compounds.

TABLE IV

| | | | | |
|---|---|---|---|---|
| Component | Name | Eq. Wt. | Example 18 | Example 19 |

Polyol-based Compositions: (parts by weight)

| | | | | |
|---|---|---|---|---|
| Polyol 1 | Terol ® 588R | 229 | 100.00 | — |
| Polyol 2 | DS 783-1 | 229 | — | 100.00 |
| F.R. Additive | Fyrol PCF | | 15.00 | 15.00 |
| Surfactant | B-8479 | | 2.00 | 2.00 |
| Catalyst 1 | Polycat 5 | | 0.25 | 0.30 |
| Catalyst 2 | K Oct | 165 | 3.30 | 3.30 |
| Catalyst 3 | K Ace | 71 | 1.85 | 1.65 |
| Water | | 9 | 0.80 | 0.80 |
| Blowing Agent | n-Pentane | | 22.00 | 23.00 |
| Total B-side | | | 145.20 | 146.05 |
| Index on B-side | | | 3.000 | 3.000 |
| Isocyanate | M 489 | 134 | 229.79 | 228.66 |
| A:B Ratio | | | 1.583 | 1.566 |
| % Blowing agent in foam | | | 6.23 | 6.50 |
| Reactivity and Form Properties: | | | | |
| Cream @ 20° C. (sec.) | | | 17 | 17 |
| String gel @ 20° C. (sec.) | | | 36 | 35 |
| Tackfree @ 20° C. (sec.) | | | 51 | 49 |
| Core Density (pcf) | | | 1.83 | 1.82 |
| Compresive Strength (psi) | | | | |
| Yield-Parallel | | | 33.2 | 39.1 |
| Yield-Perpendicular | | | 17.3 | 15.6 |
| Hotplate Test | | | | |
| % Mass Retention | | | 87.5 | 89.9 |
| % Thickness Retention | | | 104.6 | 116.2 |
| B2 Test (DIN 4102-2) | | | | |
| Average (cm) | | | 11.4 | 11.4 |
| Range (cm) | | | 11-12 | 11-12 |
| Standard Dev. (± cm) | | | 0.55 | 0.55 |
| Dimensional Stability (% ΔV) | | | | |
| Day 1 | | | | |
| −10° F. | | | −0.16 | −0.08 |
| 158° F. & 97% Rel. Humidity | | | 1.16 | 2.49 |
| 158° F. | | | −0.02 | 1.14 |
| Day 4 | | | | |
| −10° F. | | | 0.30 | 1.21 |
| 158° F. & 97% Rel. Humidity | | | 3.06 | 4.27 |
| 158° F. | | | 1.31 | 1.92 |
| Day 7 | | | | |
| −10° F. | | | 0.12 | 0.67 |
| 158° F. & 97% Rel. Humidity | | | 2.82 | 4.32 |
| 158° F. | | | 1.14 | 1.47 |
| Day 14 | | | | |
| −10° F. | | | −0.15 | 0.83 |
| 158° F. & 97% Rel. Humidity | | | 3.36 | 4.74 |
| 158° F. | | | 1.30 | 2.02 |

In Table IV above, Fyrol PCF is a flame retardant additive available from Akzo Nobel. B-8479 is a silicone-based cell stabilizing surfactant available from Goldschmidt Chemical Corp. Polycat® 5 is a catalyst available from Air Products. M 489 is Mondur® 489, a polymeric diphenyl-methane diisocyanate available from Bayer.

### Examples 20 & 21

Table V compares the physical properties of another exemplary polyol made according to the present invention, DS 1027, with those of Comparative Polyol No. 1

TABLE V

| | | | | | Water |
|---|---|---|---|---|---|
| | | Viscosity | | | Solubility |
| Sample | OH No. | (cp) | Acid No. | % Water | (pphp) |
| DS 1027 | 108 | 5560 | 1.1 | 0.15 max | >100 |
| Comparative | 110 | 3750 | 1.5 | 0.15 max | 4 |
| Polyol No. 1 | | | | | |

The two aromatic polyester polyols from Table V were formulated into polyol-based compositions using water as a blowing agent. These polyol-based compositions were then reacted with a suitable polyisocyanate to form water-blown polyisocyanurate foams. Table VI below shows the various additives and other ingredients used to formulate the polyol-based compositions, as well as the physical properties of the compositions and the blown polyisocyanurate foams prepared therefrom. As demonstrated in Table VI, water blown foams having comparable physical properties can likewise by prepared using aromatic polyester polyols that include inter-esterified low molecular weight sulfonated compounds.

TABLE VI

| | | Example | Example |
|---|---|---|---|
| Component | Name | 20 | 21 |

Polyol-based Compositions: (parts by weight)

| | | | |
|---|---|---|---|
| Polyol 1 | Comparative | 100.00 | — |
| | Polyol No. 1 | | |
| Polyol 2 | DS 1027 | — | 100.00 |
| F.R. Additive | Antiblaze 80 | 20.00 | 20.00 |
| Surfactant | Vorasurf 504 | 3.00 | 3.00 |
| Catalyst 1 | Dabco BL-17 | 4.00 | 4.00 |
| Catalyst 2 | Toyacat DM70 | 2.00 | 2.00 |
| Water | | 20.00 | 20.00 |
| Total B-side | | 149.00 | 149.00 |
| Isocyanate | M 489 | 156.45 | 156.45 |
| A:B Ratio | | 1.050 | 1.050 |
| Reactivity and Form Properties: | | | |
| Cream @ 20° C. (sec.) | | 27 | 25 |
| String gel @ 20° C. (sec.) | | 74 | 65 |
| Tackfree @ 20° C. (sec.) | | 86 | 85 |
| Core Density (pcf) | | 0.78 | 0.8 |
| Compresive Strength (psi) | | | |
| Yield-Parallel | | 4.0 | 4.5 |
| Yield-Perpendicular | | 1.6 | 1.3 |
| Dimensional Stability (% ΔV) | | | |
| Day 3 | | | |
| −20° F. | | −0.43 | −0.50 |
| 158° F. & 97% Rel. Humidity | | −5.98 | −5.65 |
| 158° F. | | −1.86 | −2.80 |
| % Closed Cell Content | | 2.2 | 0.9 |
| % Open Cell Content | | 97.8 | 99.1 |
| Stability of Polyol-based | | Unstable | Stable |
| Compositions (B-sides) | | | |

In Table VI above, Antiblaze 80 is a flame retardant additive available from Albemarle Chemical Corporation. Vorasure 504 is a stabilizing surfactant available from Dow Chemical Company. Dabco BL-17 is a catalyst available from Air Products and Chemicals. Toyacat DM70 is a product of Tosoh USA Corporation. M 489 is Mondur® 489, a polymeric diphenyl-methane diisocyanate available from Bayer.

What is claimed is:

1. A polyol-based composition comprising:
(A) a polyol component comprising:
(I) from about 20 to about 100 percent by weight of an aromatic polyester polyol comprising the inter-esterification product of reactants comprising:
(a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
(b) from about 10 to about 70 percent by weight of at least one hydroxylated material having a functionality of at least 2; and
(c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups, and mixtures thereof; and
(II) from 0 to about 80 percent by weight of a polyether polyol; and
(B) from about 0.1 to about 35 parts per hundred of polyol component, of an added blowing agent.

2. The polyol-based composition of claim 1, wherein the hydroxylated material comprises at least one low molecular weight aliphatic diol of the formula:
HO—R₁—OH
wherein R₁ is a divalent radical selected from the group consisting of:
(i) alkylene radicals each containing from 2 through 12 carbon atoms;
(ii) radicals of the formula —[CH₂—R₂—H₂]— wherein R₂ is a radical selected from the group consisting of 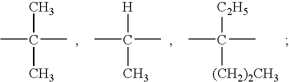
and
(iii) radicals of the formula —[(R₃O)ₙ—R₃]—
wherein R₃ an alkylene radical containing from 2-4 carbon atoms and n is an integer from 1 through 10.

3. The polyol-based composition of claim 1, wherein the low molecular weight sulfonated compound has the general formula: 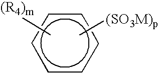
wherein
each R₄ is a radical independently selected from the group consisting of carboxylic acid groups, carboxylic acid ester group and amine groups;
m is 1, 2, 3 or 4;
M is hydrogen or a cation; and
p is 1, 2 or 3.

4. The polyol-based composition of claim 3, wherein the low molecular weight sulfonated compound is a metal salt of 5-sulfoisophthalic acid or a metal salt of a lower alkyl ester of 5-sulfoisophthalate.

5. The polyol-based composition of claim 1, wherein the low molecular weight sulfonated compound is a metal salt of a sulfonated aliphatic dicarboxylic acid having between about 3 and 8 carbons.

6. The polyol-based composition of claim 1, wherein the reactants further comprise from more than 0 to about 50 percent by weight at least one hydrophobic material characterized by
(i) containing from about 8 to 60 carbon atoms; and
(ii) containing at least one and not more than four radicals per molecule, the radicals being selected from the group consisting of carboxylic acid groups, carboxylic acid ester groups, hydroxyl groups, and mixtures thereof.

7. The polyol-based composition of claim 6, wherein the hydrophobic material is selected from the group consisting of castor oil, coconut oil, corn oil, cottonseed oil, linseed oil, olive oil, palm oil, palm kernel oil, peanut oil, soybean oil, sunflower oil, tall oils, tallow and mixtures thereof.

8. The polyol-based composition of claim 2, wherein the low molecular weight aliphatic diol is selected from the group consisting of ethylene glycol, diethylene glycol, triethylene glycol, tetraethylene glycol, propylene glycol, dipropylene glycol, 1,4-butanediol, 1,6-hexanediol, pentaerythritol monoformal and mixtures thereof

9. The polyol-based composition of claim 2, wherein the hydroxylated material further comprises from more than 0 to about 10 percent by weight at least one low molecular weight aliphatic higher functional polyol having less than about 7 carbons and between three and about eight hydroxyl groups.

10. The polyol-based composition of claim 9, wherein the low molecular weight aliphatic higher functional polyol is selected from the group consisting of glycerol, 1,1,1-trimethylol-propane, 1,1,1-trimethylolethane, pentaerythritol, 1,2,6-hexanetriol, dipentaerythritol and mixtures thereof.

11. The polyol-based composition of claim 1, wherein the blowing agent is selected from the group consisting of added water, C₄-C₇ hydrocarbons and mixtures thereof.

12. The polyol-based composition of claim 11, wherein the blowing agent further comprises added CO₂.

13. The polyol-based composition of claim 1, wherein the blowing agent is selected from the group consisting of hydrochlorofluorocarbons, hydrofluorocarbons and perfluorinated hydrocarbons.

14. The polyol-based composition of claim 1, wherein the aromatic polyester polyol comprises the inter-esterification product of: (a) from about 30 to about 60 percent by weight of a phthalic acid based material selected from the group consisting of phthalic anhydride, terephthalic acid and mixtures thereof, (b) from about 30 to about 70 percent by weight of a low molecular weight aliphatic diol selected from the group consisting of ethylene glycol, diethylene glycol, triethylene glycol, tetraethylene glycol, propylene glycol, dipropylene glycol, 1,4-butanediol, 1,6-hexanediol and mixtures thereof, and (c) from about 0.1 to about 5 percent by weight of a salt of 5-sulfoisophthalic acid or a salt of a lower alkyl ester of 5-sulfoisophthalate; and wherein the blowing agent includes from about 10 to about 35 parts per hundred of polyol component of pentane or a mixture of pentanes.

15. The polyol-based composition of claim 14, wherein the blowing agent further comprises water in an amount of from greater than 0 to about 1.5 parts per hundred of polyol component.

16. The polyol-based composition of claim 1, wherein the aromatic polyester polyol comprises the inter-esterification product of: (a) from about 30 to about 60 percent by weight of a phthalic acid based material selected from the group consisting of phthalic anhydride, terephthalic acid and mixtures thereof, (b) from about 30 to about 70 percent by weight of a low molecular weight aliphatic diol selected from the group consisting of ethylene glycol, diethylene glycol, triethylene glycol, tetraethylene glycol, propylene glycol, dipropylene glycol, 1,4-butanediol, 1,6-hexanediol and mixtures thereof; (c) from about 0.1 to about 5 percent by weight of a salt of 5-sulfoisophthalic acid or a salt of a lower alkyl ester of 5-sulfoisophthalate; and (d) from about 5 to about 25 percent by weight of a fat or oil; and wherein the blowing agent includes from about 0.1 to about 30 parts per hundred of polyol component of water.

17. A hydrocarbon-blown polyurethane or polyisocyanurate foam formed by reacting a polyisocyanate with the polyol-based composition of claim 1.

18. A water-blown polyurethane or polyisocyanurate foam formed by reacting a polyisocyanate with the polyol-based composition of claim 1.

19. A polyurethane or polyisocyanurate foam formed by reacting a polyisocyanate with the polyol-based composition of claim 14.

20. A polyurethane or polyisocyanurate foam formed by reacting a polyisocyanate with the polyol-based composition of claim 16.

21. A method for preparing a polyisocyanate-based foam, comprising reacting a polyisocyanate and a polyol-based composition as in any of claims 1-16.

22. The method of claim 21, wherein the blowing agent is selected from the group consisting of water, C₄-C₇ hydrocarbons and mixtures thereof.

23. An aromatic polyester polyol suitable for use in polyisocyanurate or polyurethane foams, comprising the inter-esterification product of reactants comprising:
(a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
(b) from about 10 to about 70 percent by weight of at least one hydroxylated material having a functionality of at least 2;
(c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups; and mixtures thereof; and
(d) from more than 0 to about 50 percent by weight at least one hydrophobic material characterized by
(i) containing from about 8 to 60 carbon atoms; and
(ii) containing at least one and not more than four radicals per molecule, the radicals being selected from the group consisting of carboxylic acid groups, carboxylic acid ester groups, hydroxyl groups, and mixtures thereof;
the aromatic polyester polyol being characterized by having:
(1) an hydroxyl number ranging from about 30 to about 500;
(2) an acid number ranging from about 0.1 to about 7;
(3) a functionality of from about 1.5 to about 3; and
(4) a viscosity ranging from about 200 to about 50,000 centipoises at 25° C., measured using a Brookfield viscometer.

24. A polyol component comprising:
(I) from about 20 to about 100 percent by weight of an aromatic polyester polyol comprising the inter-esterification product of reactants comprising:
(a) from about 10 to about 70 percent by weight of at least one phthalic acid based material selected from the group consisting of phthalic anhydride, phthalic acid, isophthalic acid, terephthalic acid, methyl esters of phthalic, isophthalic or terephthalic acid, dimethyl terephthalate, polyethylene terephthalate, polyalkylene terephthalate, trimellitic anhydride, pyromellitic dianhydride, DMT process residue, and mixtures thereof;
(b) from about 10 to about 70 percent by weight of at least one hydroxylated material having a functionality of at least 2; and
(c) from about 0.1 to about 10 percent by weight at least one low molecular weight sulfonated compound having between one and three sulfonate groups and from one to about four radicals selected from the group consisting of carboxylic acid groups, carboxylic acid ester groups, hydroxyl groups, amine groups, and mixtures thereof.

25. The polyol-based composition of claim 24, wherein the hydroxylated material comprises at least one low molecular weight aliphatic diol of the formula:
HO—R₁—OH
wherein R₁ is a divalent radical selected from the group consisting of:
(i) alkylene radicals each containing from 2 through 12 carbon atoms;
(ii) radicals of the formula —[CH₂—R₂—CH₂]— wherein R₂ is a radical selected from the group consisting of 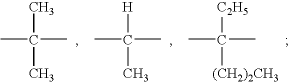
and
(iii) radicals of the formula —[(R₃O)ₙ—R₃]—
wherein R₃ an alkylene radical containing from 2-4 carbon atoms and n is an integer from 1 through 10.

26. The polyol-based composition of claim 24, wherein the low molecular weight sulfonated compound has the general formula: 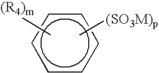
wherein
each R₄ is a radical independently selected from the group consisting of carboxylic acid groups, carboxylic acid ester group and amine groups;
m is 1, 2, 3 or 4;
M is hydrogen or a cation; and
p is 1, 2 or 3.

27. The polyol-based composition of claim 26, wherein the low molecular weight sulfonated compound is a metal salt of 5-sulfoisophthalic acid or a metal salt of a lower alkyl ester of 5-sulfoisophthalate.

28. The polyol-based composition of claim 24, wherein the low molecular weight sulfonated compound is a metal salt of a sulfonated aliphatic dicarboxylic acid having between about 3 and 8 carbons.
